(19) United States
(12) Patent Application Publication
(10) Pub. No.: US 2026/0063822 A1
(43) Pub. Date: Mar. 5, 2026

(54) MODEL TRAINING METHOD AND STRATIGRAPHIC DIVISION CONCLUSION EXTRACTION METHOD

(71) Applicants: CHINA UNIVERSITY OF PETROLEUM—BEIJING, Beijing (CN); China National Logging Corporation, Xi 'an (CN)

(72) Inventors: Juan ZHANG, Beijing (CN); Guangzhi LIAO, Beijing (CN); Jun ZHOU, Beijing (CN); Yubo LIU, Beijing (CN); Xiugang MA, Beijing (CN); Xiaolei CHEN, Beijing (CN); Jianjian LIU, Beijing (CN); Xianfei DUAN, Beijing (CN); Bowen HOU, Beijing (CN); Huikun DONG, Beijing (CN)

(21) Appl. No.: 19/028,518

(22) Filed: Jan. 17, 2025

(30) Foreign Application Priority Data
Sep. 5, 2024 (CN) 202411245462.X

(51) Int. Cl. G01V 11/00; G06N 3/08

(52) U.S. Cl. CPC G01V 11/002; G06N 3/08

(57) ABSTRACT

The present application provides a model training method and a stratigraphic division conclusion extraction method. The model training method includes: obtaining multiple first logging curves of a target logging well, where the multiple first logging curves are respectively configured to indicate depth, natural gamma, natural potential, acoustic time difference and bilateral resistivity; pre-processing the multiple first logging curves to obtain a second logging curve corresponding to each of the first logging curves; performing a multi-scale wavelet decomposition on target segment lengths of multiple second logging curves to obtain a multi-scale component corresponding to each of the second logging curves; and inputting sample point data of the target segment length of each of the second logging curves and the corresponding multi-scale component into a pre-constructed multi-level bidirectional long short-term memory network so as to obtain a first stratigraphic division conclusion corresponding to each of the second logging curves.

### CROSS-REFERENCE TO RELATED APPLICATIONS

This application claims priority to Chinese Patent Application No. 202411245462.X, filed on Sep. 5, 2024 and entitled “MODEL TRAINING METHOD AND STRATIGRAPHIC DIVISION CONCLUSION EXTRACTION METHOD”, which is hereby incorporated by reference in its entirety.

### TECHNICAL FIELD

The present application relates to the technical field of logging curve data analysis and, in particular, to a model training method and a stratigraphic division conclusion extraction method.

### BACKGROUND

Petroleum, as an important strategic material, is closely related to social's economic development, and plays a crucial role in ensuring a normal operation and economic development of the society. Petroleum exploration technology aims to explore and analysis potential oil and gas reservoirs through geological, geophysical and other related methods. As one of the core technologies in petroleum exploration, logging technology mainly collects data on the physical, chemical and other properties of rock strata by lowering logging instruments into wells during a drilling process or after the drilling is completed. Stratigraphic division plays a key role in the petroleum exploration: the stratigraphic division can provide necessary design and operational information for the logging technology; the characteristics of rocks and sediments in different strata affect the location and distribution of the oil and gas reservoirs, and the reserves, production and economic value of the oil and gas reservoirs can be analyzed through detailed stratigraphic division; at the same time, the stratigraphic division can help determine the location and distribution of the oil and gas reservoirs, and potential oil and gas reservoir areas can be identified and their specific locations underground can be determined by analyzing the sedimentary environment, lithological changes and geological structure of the strata. Therefore, it is crucial to study the stratigraphic division in the petroleum exploration.

In the prior art, the stratigraphic division is based on scientific methods and evidence, but stratigraphic division conclusions drawn from this basis are human-made, that is, this method requires researchers to obtain the stratigraphic division conclusions through personal experience and scientific evidence. Therefore, the stratigraphic division conclusions drawn by using the existing methods are subjective, and different researchers may obtain different results, resulting in poor repeatability in the stratigraphic division.

### SUMMARY

The present application provides a model training method and a stratigraphic division conclusion extraction method, so as to solve a problem of low repeatability caused by obtaining stratigraphic division conclusions through existing technologies.

In a first aspect, an embodiment of the present application provides a model training method, including:
obtaining a plurality of first logging curves of a target logging well, where a plurality of the first logging curves are respectively used to indicate depth, gamma ray, spontaneous potential, acoustic velocity and dual laterolog resistivity;
pre-processing a plurality of the first logging curves to obtain a second logging curve corresponding to each of the first logging curves;
performing a multi-scale wavelet decomposition on target segment lengths of a plurality of the second logging curves to obtain a multi-scale component corresponding to each of the second logging curves; and
inputting sample point data of the target segment length of each of the second logging curves and the multi-scale component corresponding to each of the second logging curves into a pre-constructed multi-level bidirectional long short-term memory network so as to train the multi-level bidirectional long short-term memory network; where the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

In an embodiment, a second target logging curve is any one of a plurality of the second logging curves;
for the second target logging curve, the performing the multi-scale wavelet decomposition on target segment lengths of a plurality of the second logging curves to obtain the multi-scale component corresponding to each of the second logging curves includes:
obtaining a target segment length, target decomposition wavelet basis and a target decomposition level of the second target logging curve according to a pre-stored stratigraphic division accuracy rate;
performing at least one wavelet decomposition on the target segment length of the second target logging curve according to the target decomposition level and the target decomposition wavelet basis of the second target logging curve; and
obtaining the multi-scale component corresponding to the second target logging curve according to low-frequency components obtained from each wavelet decomposition; where the multi-scale component corresponding to the second target logging curve refers to a set of at least one of the low-frequency components.

In an embodiment, the performing at least one wavelet decomposition on the target segment length of the second target logging curve according to the target decomposition level and the target decomposition wavelet basis of the second target logging curve includes:
performing at least one wavelet decomposition on the target segment length of the second target logging curve according to the target decomposition wavelet basis of the second target logging curve until that the number of the wavelet decompositions reaches the target decomposition level of the second target logging curve;
a target-order wavelet decomposition is any one of the at least one wavelet decomposition, and after performing the target-order wavelet decomposition on the target segment length of the second target logging curve according to the target decomposition wavelet basis of the second target logging curve, the method further includes:
updating the target segment length to the low-frequency component obtained from the target-order wavelet decomposition.

In an embodiment, after inputting the sample point data of the target segment length of each of the second logging curves and the multi-scale component corresponding to each of the second logging curves into the pre-constructed multi-level bidirectional long short-term memory network so as to train the multi-level bidirectional long short-term memory network, the method further includes:
inputting the sample point data of the target segment length of each of the second logging curves and the multi-scale component corresponding to each of the second logging curves into a pre-constructed long short-term memory network to obtain a second stratigraphic division conclusion corresponding to each of the second logging curves output by the long short-term memory network;
obtaining a first stratigraphic division fusion conclusion obtained by fusing a plurality of the first stratigraphic division conclusions and a second stratigraphic division fusion conclusion obtained by fusing a plurality of the second stratigraphic division conclusions through a pre-stored adaptive fusion network according to a plurality of the first stratigraphic division conclusions and a plurality of the second stratigraphic division conclusions;
obtaining respective stratigraphic division accuracy rates for a plurality of the first stratigraphic division conclusions, a plurality of the second stratigraphic division conclusions, the first stratigraphic division fusion conclusion and the second stratigraphic division fusion conclusion; and
obtaining a training result of the multi-level bidirectional long short-term memory network after completion of the training according to a plurality of the stratigraphic division accuracy rates, where the training result indicates that the training is successful, and is used to indicate that the stratigraphic division accuracy rate of the multi-level bidirectional long short-term memory network after completion of the training is higher than that of the long short-term memory network.

In an embodiment, a first fusion network formula and a second fusion network formula are pre-stored in the adaptive fusion network;
when the adaptive fusion network is a two-layer partially connected network, the obtaining the first stratigraphic division fusion conclusion obtained by fusing a plurality of the first stratigraphic division conclusions and the second stratigraphic division fusion conclusion obtained by fusing a plurality of the second stratigraphic division conclusions through the pre-stored adaptive fusion network according to a plurality of the first stratigraphic division conclusions and a plurality of the second stratigraphic division conclusions includes:
obtaining a first prediction probability according to a plurality of the first stratigraphic division conclusions through a first fusion network formula; and the first fusion network formula is:

$${\tilde{P}}_{j} = ( ReLU ( {G}_{j} {W}_{k} + {b}_{k} ) ) {W}_{1} + {b}_{1}$$

where, \tilde{P}ⱼ is the first prediction probability, ReLU( )is a linear correction function, Gⱼ is a fusion conclusion obtained according to a plurality of the first stratigraphic division conclusions, Wₖ is a partially connected layer with k nodes, bₖ is a bias of the partially connected layer, W₁ is an output layer, and b₁ is a bias of the output layer;
obtaining the first stratigraphic division fusion conclusion according to the first prediction probability;
obtaining a second prediction probability according to a plurality of the second stratigraphic division conclusions through a second fusion network formula; and the second fusion network formula is:

$$= ( ReLU ( {G}_{m} {W}_{k} + {b}_{k} ) ) {W}_{1} + {b}_{1}$$

where, [symbol] is the second prediction probability, and Gₘ is a fusion conclusion according to a plurality of the second stratigraphic division conclusions; and
obtaining the second stratigraphic division fusion conclusion according to the second prediction probability.

In an embodiment, the multi-level bidirectional long short-term memory network includes n+1 network layers, and the target segment length of the second target logging curve is subjected to the wavelet decomposition for n times;
the inputting the sample point data of the target segment length of each of the second logging curves and the multi-scale component corresponding to each of the second logging curves into the pre-constructed multi-level bidirectional long short-term memory network so as to train the multi-level bidirectional long short-term memory network includes:
inputting the sample point data of the target segment length of each of the second logging curves into a first network layer of the multi-level bidirectional long short-term memory network; and
inputting the low-frequency component obtained from the i-th wavelet decomposition into an (i+1)th network layer of the multi-level bidirectional long short-term memory network, so as to train the multi-level bidirectional long short-term memory network; where the i is a positive integer less than or equal to the n.

In an embodiment, a first target logging curve is any one of a plurality of the first logging curves;
for the first target logging curve, the pre-processing a plurality of the first logging curves to obtain the second logging curve corresponding to each of the first logging curves includes:
performing outlier processing on the first target logging curve; and
normalizing the sample point data of the first logging curve after the outlier processing through a normalization processing formula, so as to obtain the sample point data of the second logging curve corresponding to the first target logging curve.

In a second aspect, an embodiment of the present application provides a stratigraphic division conclusion extraction method, including:
obtaining a plurality of third logging curves of a logging well to be tested, where a plurality of the third logging curves are respectively used to indicate depth, gamma ray, spontaneous potential, acoustic velocity and dual laterolog resistivity;
pre-processing a plurality of the third logging curves to obtain a fourth logging curve corresponding to each of the third logging curves;
performing a multi-scale wavelet decomposition on target segment lengths of a plurality of the fourth logging curves to obtain a multi-scale component corresponding to each of the fourth logging curves; and
inputting sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves; where the multi-level bidirectional long short-term memory network is a model obtained by using the model training method provided in the first aspect of the present application.

In an embodiment, after inputting the sample point data of the target segment length of each of the fourth logging curves and the multi-scale component corresponding to each of the fourth logging curves into the pre-stored multi-level bidirectional long short-term memory network to obtain the third stratigraphic division conclusion corresponding to each of the fourth logging curves, the method further includes:
obtaining a third stratigraphic division fusion conclusion obtained by fusing a plurality of the third stratigraphic division conclusions through a pre-stored adaptive fusion network according to a plurality of the third stratigraphic division conclusions.

In an embodiment, a third fusion network formula is pre-stored in the adaptive fusion network;
when the adaptive fusion network is a two-layer partially connected network, the obtaining the third stratigraphic division fusion conclusion obtained by fusing a plurality of the third stratigraphic division conclusions through the pre-stored adaptive fusion network according to a plurality of the third stratigraphic division conclusions, including:
obtaining a third prediction probability according to a plurality of the third stratigraphic division conclusions through the third fusion network formula; and the third fusion network formula is:

$$= ( ReLU ( {G}_{n} {W}_{k} + {b}_{k} ) ) {W}_{1} + {b}_{1}$$

where, [symbol] is the third prediction probability, ReLU( )is a linear correction function, Gⱼ is a fusion conclusion obtained according to a plurality of the third stratigraphic division conclusions, Wₖ is a partially connected layer with k nodes, bₖ is a bias of the partially connected layer, W₁ is an output layer, and b₁ is a bias of the output layer; and
obtaining the third stratigraphic division fusion conclusion according to the third prediction probability.

In a third aspect, an embodiment of the present application provides a model training apparatus, including:
an obtaining module, configured to obtain a plurality of first logging curves of a target logging well, where a plurality of the first logging curves are respectively used to indicate depth, gamma ray, spontaneous potential, acoustic velocity and dual laterolog resistivity;
a pre-processing module, configured to pre-process a plurality of the first logging curves to obtain a second logging curve corresponding to each of the first logging curves;
a wavelet decomposing module, configured to perform a multi-scale wavelet decomposition on target segment lengths of a plurality of the second logging curves to obtain a multi-scale component corresponding to each of the second logging curves; and
a training module, configured to input sample point data of the target segment length of each of the second logging curves and the multi-scale component corresponding to each of the second logging curves into a pre-constructed multi-level bidirectional long short-term memory network so as to train the multi-level bidirectional long short-term memory network; where the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

In a fourth aspect, an embodiment of the present application provides a stratigraphic division conclusion extraction apparatus, including:
an obtaining module, configured to obtain a plurality of third logging curves of a logging well to be tested, where a plurality of the third logging curves are respectively used to indicate depth, gamma ray, spontaneous potential, acoustic velocity and dual laterolog resistivity;
a pre-processing module, configured to preprocess a plurality of the third logging curves to obtain a fourth logging curve corresponding to each of the third logging curves;
a wavelet decomposing module, configured to perform a multi-scale wavelet decomposition on target segment lengths of a plurality of the fourth logging curves to obtain a multi-scale component corresponding to each of the fourth logging curves; and
an extracting module, configured to input sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves.

In a fifth aspect, an embodiment of the present application provides an electronic device, including: a processor and a memory in communication with the processor; where
the memory stores computer-executable instructions; and
the processor executes the computer-executable instructions stored in the memory, so as to implement the model training method provided in the first aspect of the present application or the stratigraphic division conclusion extraction method provided in the second aspect of the present application.

In a sixth aspect, an embodiment of the present application provides a computer-readable storage medium, where the computer-readable storage medium stores computer-executable instructions, so as to implement the model training method provided in the first aspect of the present application or the stratigraphic division conclusion extraction method provided in the second aspect of the present application.

In a seventh aspect, an embodiment of the present application provides a computer program product, including a computer program which, when being executed by a processor, implements the model training method provided in the first aspect of the present application or the stratigraphic division conclusion extraction method provided in the second aspect of the present application.

The present application provides a model training method and a stratigraphic division conclusion extraction method, and the model training method includes: obtaining a plurality of the first logging curves of the target logging well, where a plurality of the first logging curves are respectively used to indicate depth, gamma ray, spontaneous potential, acoustic velocity and dual laterolog resistivity; pre-processing a plurality of the first logging curves to obtain the second logging curve corresponding to each of the first logging curves; performing the multi-scale wavelet decomposition on the target segment lengths of a plurality of the second logging curves to obtain the multi-scale component corresponding to each of the second logging curves; and inputting the sample point data of the target segment length of each of the second logging curves and the multi-scale component corresponding to each of the second logging curves into the pre-constructed multi-level bidirectional long short-term memory network so as to train the multi-level bidirectional long short-term memory network; where the multi-level bidirectional long short-term memory network is constructed by a plurality of the bidirectional long short-term memory networks with different network parameters; and the multi-level bidirectional long short-term memory network after completion of training is configured to output the first stratigraphic division conclusion corresponding to each of the second logging curves. According to the above-described method, the following technical effects have been achieved: by performing the multi-scale wavelet decomposition on the logging curves, temporal features of the logging data are extracted at multiple scales, so as to obtain richer features and facilitate obtaining a more accurate stratigraphic division. By combining the traditional wavelet transformation with the multi-level bidirectional long short-term memory network in deep learning, the features obtained after the wavelet transformation does not need to be analyzed artificially, and the temporal components of the logging curves can be automatically learned from multiple scales, thereby automatically obtaining the stratigraphic division conclusions based on different curves.

### BRIEF DESCRIPTION OF THE DRAWINGS

In order to illustrate technical solutions in the embodiments of the present application or in the prior art more clearly, a brief introduction will be given to the accompanying drawings required for the description of the embodiments or the prior art below. Obviously, the accompanying drawings in the following description are some embodiments of the present application, and for those ordinary skilled in the art, other accompanying drawings can also be obtained from these accompanying drawings without creative efforts.

FIG. 1 is a first schematic flowchart of a model training method provided in an embodiment of the present application.

FIG. 2 is a second schematic flowchart of the model training method provided in an embodiment of the present application.

FIG. 3 is the first schematic flowchart of a stratigraphic division conclusion extraction method provided in an embodiment of the present application.

FIG. 4 is a second schematic flowchart of the stratigraphic division conclusion extraction method provided in an embodiment of the present application.

FIG. 5 is a schematic structural diagram of a model training apparatus provided in an embodiment of the present application.

FIG. 6 is a schematic structural diagram of a stratigraphic division conclusion extraction apparatus provided in an embodiment of the present application.

FIG. 7 is a schematic structural diagram of an electronic device provided in an embodiment of the present application.

### DESCRIPTION OF EMBODIMENTS

In the embodiments of the present application, terms such as “first”, “second” etc. are used to distinguish the same or similar items whose functions and effects are basically the same. Those skilled in the art should understand that the terms such as “first”, “second” etc. do not limit the quantity and execution order, and also do not necessarily imply differences. It should be noted that, in the embodiments of the present application, terms such as “exemplary” or “for example” are used to denote examples, illustrations, or explanations. Any embodiments or design schemes described as “exemplary” or “for example” in the present application should not be interpreted as being more preferred or advantageous over other embodiments or design schemes. Specifically, the terms such as “exemplary” or “for example” etc. intended to present related concepts in a concrete manner. In the embodiments of the present application, the “at least one” refers to one or more, and the “a plurality of” refers to two or more.

It should be noted that, in the embodiments of the present application, the “at the time of . . . ” may refer to a moment when a certain condition occurs, and may also be within a period of time after the certain condition occurs, which is not specifically limited in the embodiments of the present application. In addition, a model training method provided in the embodiments of the present application is merely an example, and the model training method may also include more or fewer contents.

In order to be convenient for a clear description of the technical solution in the embodiments of the present application, some terms and technologies involved in the embodiments of the present application are briefly introduced below.

Long short-term memory network: a special recurrent neural network aims to solve the problems of gradient disappearance and gradient explosion encountered by traditional recurrent neural networks when processing long-term sequences. The long short-term memory network can store information over a long time span by introducing memory units, thereby solving a memory loss problem of traditional recurrent neural networks in long sequence processing. The long short-term memory network controls the flow of information through an input gate, a forgetting gate and an output gate, and each gate has an independent neural network thereof, so that it can be determined which information should be retained or forgotten.

Wavelet basis: the wavelet basis are a set of wavelet functions that can effectively decompose and represent signals, and are mainly used in fields such as signal processing, data compression, noise removal, feature extraction and so on. These wavelet functions are fundamental elements of the signals that can be used to represent and analyze different characteristics of the signals.

The exemplary embodiments will be explained in detail herein, and the examples thereof are illustrated in the accompanying drawings. When referring to the accompanying drawings in the following description, unless otherwise indicated, the same numbers in different drawings represent the same or similar elements. The implementations described in the following exemplary embodiments do not represent all implementations consistent with the present application. On the contrary, they are merely examples of devices and methods that are consistent with some aspects of the present application.

The following provides a detailed explanation of the technical solution of the present application through the specific embodiments. The following several specific embodiments may be combined with each other, and the same or similar concepts or processes may not be repeated in some embodiments. Hereinafter, the embodiments of the present application will be described with reference to the accompanying drawings.

To clearly understand the technical solution of the present application, the solution in the prior art is first introduced in detail.

In the prior art, a process of stratigraphic division is based on scientific methods and evidence, but stratigraphic division conclusions drawn from this basis are human-made, that is, this method requires researchers to obtain the stratigraphic division conclusions through personal experience and scientific evidence. Therefore, the stratigraphic division conclusions drawn by using the existing methods are subjective, and different researchers may obtain different results, thereby resulting in poor repeatability in the stratigraphic division.

Therefore, with regard to the problem of poor repeatability caused by obtaining the stratigraphic division through existing technologies, it was found in the research that in order to solve this problem, the following steps are taken: \textcircled{1} obtaining commonly used logging curves of a target logging well; \textcircled{2} after pre-processing the commonly used logging curves, performing a multi-scale wavelet transformation on them so as to obtain corresponding multi-scale components; \textcircled{3} training a multi-level bidirectional long short-term memory network based on the commonly used logging curves and their corresponding multi-scale components.

Specifically, obtaining a plurality of first logging curves of a target logging well, where a plurality of the first logging curves are respectively used to indicate depth, gamma ray, spontaneous potential, acoustic velocity and dual laterolog resistivity;
pre-processing a plurality of the first logging curves to obtain a second logging curve corresponding to each of the first logging curves;
performing a multi-scale wavelet decomposition on target segment lengths of a plurality of the second logging curves to obtain a multi-scale component corresponding to each of the second logging curves; and
inputting sample point data of the target segment length of each of the second logging curves and the multi-scale component corresponding to each of the second logging curves into a pre-constructed multi-level bidirectional long short-term memory network so as to train the multi-level bidirectional long short-term memory network; where the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

According to the model training method in the embodiments of the present application, the present application combines the wavelet transformation with the multi-level bidirectional long short-time memory network based on a principle of preset conditions of the above working conditions, and uses the commonly used logging curves and the corresponding multi-scale components thereof obtained after the wavelet transformation to train the multi-level bidirectional long short-term memory network, so as to automatically extract the stratigraphic division conclusions corresponding to the commonly used logging curves, thereby avoiding the problem of poor repeatability caused by subjective judgments.

Based on the described inventive discovery, the technical solution of the present application is proposed.

The application scenarios of the model training method provided in the embodiments of the present application will be introduced below.

The model training method of the present solution can be applicable to a plurality of scenarios: in an exploration of petroleum and natural gas, it is crucial for determining a location and scale of oil and gas reservoirs to identify and classify the strata accurately. Based on the model after training is completed through the model training method of the present application, required stratigraphic information can be automatically extracted from seismic data, drilling data, and core samples, thereby providing a more accurate stratigraphic division. By automatically extracting the stratigraphic division conclusions, stability of geological structures can be obtained, which is helpful to formulate disaster prevention measures. In engineering construction, automated analysis of the stratigraphic division conclusions can provide accurate geological information to support environment influence analysis and engineering design.

The embodiments of the present application will be introduced in conjunction with the accompanying drawings below.

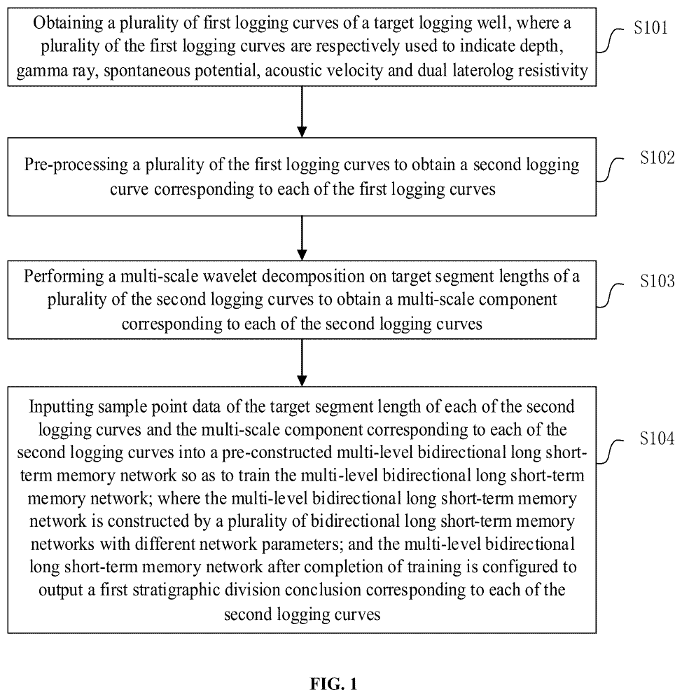

FIG. 1 is a first schematic flowchart of a model training method provided in an embodiment of the present application, and the model training method provided in the present embodiment includes the following steps.

S101, obtaining a plurality of first logging curves of a target logging well, where a plurality of the first logging curves are respectively used to indicate depth, gamma ray, spontaneous potential, acoustic velocity and dual laterolog resistivity.

In the present embodiment, logging curve data of the same oilfield block is firstly obtained, and a well with a relatively close distance and similar features to a logging well to be tested is selected as the target logging well according to coordinate information of the wells. Secondly, a plurality of the first logging curves are obtained from the logging curve data of the target logging well, i.e., a depth curve, a gamma ray curve (GR), a spontaneous potential curve (SP), an acoustic velocity curve (AC), and dual laterolog resistivity curves (RT1, RT2), as research data for feature learning.

S102, pre-processing a plurality of the first logging curves to obtain a second logging curve corresponding to each of the first logging curves.

In the present embodiment, the second logging curve corresponding to each of the first logging curves refers to a plurality of logging curves obtained after pre-processing a plurality of the first logging curves. The purpose of pre-processing a plurality of the first logging curves is to eliminate outliers and features with large value ranges in the sampling point data of a plurality of the first logging curves, so as to prevent certain features with large value ranges in the sampling point data from dominating the model effect, causing the model to ignore those features that are numerically small but important.

S103, performing a multi-scale wavelet decomposition on target segment lengths of a plurality of the second logging curves to obtain a multi-scale component corresponding to each of the second logging curves.

In the present embodiment, wavelet basis is selected to perform the multi-scale decomposition on the target segment lengths of the second logging curves, that is, on the target segment lengths of a plurality of the logging curves after pre-processing. By extracting temporal features of the logging data at multiple scales, richer features can be obtained, thereby facilitating obtaining a more accurate stratigraphic division. Through the multi-scale decomposition, noise and useful information in the sampling point data of the logging curves can be separated. High-frequency components often contain noise, while low-frequency components can better reflect actual geological information. Therefore, the gradual decomposition of the logging curves may extract useful geological information.

S104, inputting sample point data of the target segment length of each of the second logging curves and the multi-scale component corresponding to each of the second logging curves into a pre-constructed multi-level bidirectional long short-term memory network so as to train the multi-level bidirectional long short-term memory network; where the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

In the present embodiment, the sample point data of the target segment length of single preprocessed logging curve and the multi-scale component obtained after the multi-scale wavelet decomposition are input into the constructed multi-level bidirectional long short-term memory network for training, the training parameters are set, and a stratigraphic division result based on this logging curve is provided on a test set after the training is completed. By constructing and training the multi-level bidirectional long short-term memory network, the stratigraphic division conclusion based on this logging curve can be automatically extracted.

The present application provides a model training method and a stratigraphic division conclusion extraction method, and the model training method includes: obtaining a plurality of the first logging curves of the target logging well, where a plurality of the first logging curves are respectively used to indicate depth, gamma ray, spontaneous potential, acoustic velocity and dual laterolog resistivity; pre-processing a plurality of the first logging curves to obtain a second logging curve corresponding to each of the first logging curves; performing the multi-scale wavelet decomposition on target segment lengths of a plurality of the second logging curves to obtain the multi-scale component corresponding to each of the second logging curves; and inputting the sample point data of the target segment length of each of the second logging curves and the multi-scale component corresponding to each of the second logging curves into the pre-constructed multi-level bidirectional long short-term memory network so as to train the multi-level bidirectional long short-term memory network; where the multi-level bidirectional long short-term memory network is constructed by a plurality of the bidirectional long short-term memory networks with different network parameters; and the multi-level bidirectional long short-term memory network after completion of training is configured to output the first stratigraphic division conclusion corresponding to each of the second logging curves. According to the above-described method, the following technical effects have been achieved: by performing the multi-scale wavelet decomposition on the logging curves, temporal features of the logging data are extracted at multiple scales, so as to obtain richer features and facilitate obtaining a more accurate stratigraphic division. By combining the traditional wavelet transformation with the multi-level bidirectional long short-term memory network in deep learning, the features obtained after the wavelet transformation does not need to be analyzed artificially, and the temporal components of the logging curves can be automatically learned from multiple scales, thereby automatically obtaining the stratigraphic division conclusions based on different curves.

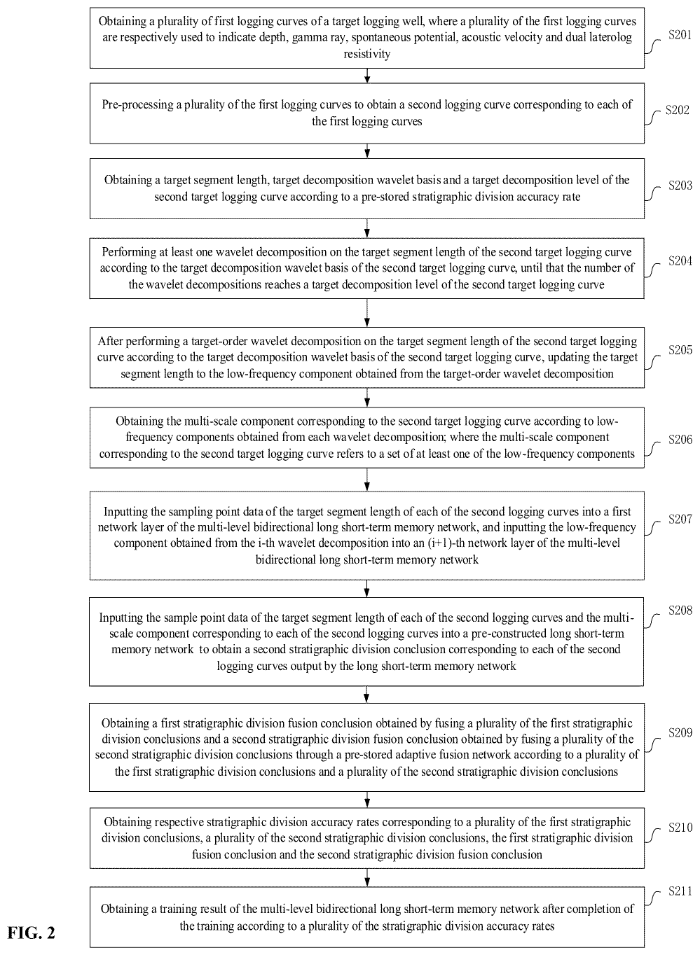

FIG. 2 is a second schematic flowchart of the model training method provided in an embodiment of the present application. As shown in FIG. 2, the model training method provided in the present embodiment is a further refinement based on the model training method provided in the previous embodiment of the present application. The model training method provided in the present embodiment includes the following steps.

S201, obtaining a plurality of first logging curves of a target logging well, where a plurality of the first logging curves are respectively used to indicate depth, gamma ray, spontaneous potential, acoustic velocity and dual laterolog resistivity.

In the present embodiment, the effect of S201 is similar to that of S101 in the previous embodiment of the present application, and thus will not be repeated herein.

S202: pre-processing a plurality of the first logging curves to obtain a second logging curve corresponding to each of the first logging curves.

In the present embodiment, a first target logging curve is any one of a plurality of the first logging curves;
for the first target logging curve, an outlier processing is performed on the first target logging curve; and
the sampling point data of the first logging curve after the outlier processing is normalized through a normalization processing formula, so as to obtain the sampling point data of the second logging curve corresponding to the first target logging curve.

Specifically, the normalization processing formula is:

$$= \frac{{x}_{i} - {x}_{m i n}}{{x}_{ma x} - {x}_{m i n}}$$

where, xᵢ is an i-th sampling point data of the first target logging curve after the outlier processing, and [symbol] is an i-th sampling point data of the second logging curve corresponding to the first target logging curve, xₘᵢₙ is a minimum value in the sampling point data of the first target logging curve after the outlier processing, and xₘₐₓ is a maximum value in the sampling point data of the first target logging curve after the outlier processing.

In the present embodiment, the effect of S202 is similar to that of S102 in the previous embodiment of the present application, and thus will not be repeated herein.

S203, obtaining a target segment length, target decomposition wavelet basis and a target decomposition level of the second target logging curve according to a pre-stored stratigraphic division accuracy rate.

In the present embodiment, the second target logging curve is any one of a plurality of the second logging curves, that is, the second target logging curve corresponds to any one of the pre-processed logging curves. For each logging curve, the target segment length, the target decomposition wavelet basis, and the target decomposition level are obtained based on the stratigraphic division accuracy rate. With regard to the selection of the target segment length of each logging curve, the number of network layers of the constructed multi-level bidirectional long short-term memory network is set to 2, and the number of hidden-layer nodes is 128. When the target segment lengths of the logging curves are 48, 96, 128, and 192 meters, the corresponding actual depths are 6, 12, 16 and 24 meters, respectively.

When performing the wavelet decomposition, it is of great significance for fully exploring the multi-scale temporal features in the logging curves to choose appropriate wavelet basis and decomposition level. The present application selects a series of wavelet basis for experimentation by conducting a detailed analysis of the logging curves, so as to determine which wavelet transformation is most suitable for specific logging curves. The use of multiple series of wavelet basis is beneficial for selecting the wavelet basis most applicable to a time-frequency analysis of the logging curves, thereby enhancing the comprehensiveness and reliability of the experiment. The target decomposition wavelet basis is chosen from several candidate wavelet basis, including classic Haar wavelet basis, Db1 and Db4 wavelet basis in the Daubechies series, sym4 wavelet basis in the Symlets series, coif1 wavelet basis in the Coiflets series, and bior2.2 wavelet basis in the Biorthogonal series, respectively. The classic Haar wavelet basis and the Db1 and Db4 wavelet basis in the Daubechies series are commonly configured to process signals with abrupt features, and may have a better analysis effect on certain curves with abrupt values. When being applied to other logging data sets, more wavelet basis may be selected for comparison experiments.

As shown in Table 1, taking a gamma curve as an example, after taking different wavelet basis to perform the wavelet decomposition on it once (i.e., the target decomposition level is 1), various indicators of the stratigraphic division based on the gamma curve are observed.

TABLE 1

| | Db1 | Db4 | Haar | sym4 | coif1 | bior2.2 |
|---|---|---|---|---|---|---|
| Accuracy rate | 58.371 | 58.815 | 59.215 | 59.680 | 58.343 | 56.480 |
| Recall rate | 47.141 | 47.407 | 48.283 | 48.849 | 48.264 | 45.336 |
| F1 coefficient | 46.815 | 47.544 | 48.430 | 48.956 | 47.882 | 44.649 |
| Time per epoch | 136.051 | 100.519 | 94.713 | 94.079 | 92.594 | 94.276 |

As shown in Table 1, when the target decomposition level is 1, various indicators of the stratigraphic division based on the gamma curve when using the sym4 wavelet basis are higher than various indicators of the stratigraphic division when using other wavelet basis, and performance of the Haar wavelet basis is close to that of the sym4 wavelet basis. Therefore, when the target decomposition level of the gamma curve is 1, the sym4 wavelet basis is taken as the target decomposition wavelet basis thereof.

For each of the logging curves, the target decomposition wavelet basis and the target decomposition level for each of the logging curves are selected through experiments. The target decomposition wavelet basis and target decomposition level of each logging curve are shown in Table 2.

TABLE 2

| | GR | SP | AC | RT1 | RT2 |
|---|---|---|---|---|---|
| Target decomposition wavelet basis | sym4 | Db1 | coif1 | Db1 | Db4 |
| Target decomposition level | 1 | 2 | 1 | 2 | 1 |

S204, performing at least one wavelet decomposition on the target segment length of the second target logging curve according to the target decomposition wavelet basis of the second target logging curve, until that the number of the wavelet decompositions reaches the target decomposition level of the second target logging curve.

In the present embodiment, the target decomposition level is typically less than 4, since excessive decomposition may introduce noise instead.

S205, after performing a target-order wavelet decomposition on the target segment length of the second target logging curve according to the target decomposition wavelet basis of the second target logging curve, updating the target segment length to the low-frequency component obtained from the target-order wavelet decomposition.

In the present embodiment, the target-order wavelet decomposition is any one of the at least one wavelet decomposition. After selecting the target segment length, the target decomposition wavelet basis, and the target decomposition level of the pre-processed logging curves through experiments, the multi-scale wavelet decomposition is performed on the pre-processed logging curves. A first wavelet decomposition is performed on the pre-processed logging curve so as to obtain a first-level low-frequency component and a first-level high-frequency component of this logging curve, where the first-level high-frequency component is added to a multi-scale database, and the first-level low-frequency component is taken as a new target segment length. A second wavelet decomposition is performed on the first-level low-frequency component taking as the new target segment length to obtain a second-level low-frequency component and a second-level high-frequency component of this logging curve, where the second-level high-frequency component is added into the multi-scale database, and the second-level low-frequency component serves as a new target segment length, and so on.

S206, obtaining the multi-scale component corresponding to the second target logging curve according to low-frequency components obtained from each wavelet decomposition; where the multi-scale component corresponding to the second target logging curve refers to a set of at least one of the low-frequency components.

In the present embodiment, the multi-scale component of the pre-processed logging curve is a set of low-frequency components obtained after the wavelet decomposition performed on the logging curve each time.

S207, inputting the sampling point data of the target segment length of each of the second logging curves into a first network layer of the multi-level bidirectional long short-term memory network, and inputting the low-frequency component obtained from the i-th wavelet decomposition into an (i+1)th network layer of the multi-level bidirectional long short-term memory network.

In the present embodiment, the purpose of step S207 is to train the multi-level bidirectional long short-time memory network, where the multi-level bidirectional long short-time memory network includes n+1 network layers, the target segment length of the second target logging curve is subjected to the wavelet decomposition for n times, and the i is a positive integer less than or equal to the n.

The multi-level bidirectional long short-term memory network is constructed by a plurality of bidirectional long short-term memory networks with network parameters that are different from each other, so as to acquire a richer feature representation of the logging data from multiple scales.

The multi-level bidirectional long short-term memory network after completion of training is configured to output a first stratigraphic division conclusion corresponding to each of the second logging curves.

The network level thereof is determined by the target decomposition level of the logging curve, where if the target decomposition level of the logging curve is 1, the network level is 2; and if the target decomposition level of the logging curve is 2, the network level is 3, and so on. The number of layers and nodes in each level of the network are determined through experiments, and the parameters of this network are determined through a plurality of experiments.

The data input into the multi-level bidirectional long short-term memory network includes the target segment length of the preprocessed logging curve, and the multi-scale component obtained after performing the wavelet decomposition on the target segment length of the logging curve. Taking the target segment length of the logging curve before the wavelet decomposition as an example, for a logging curve segment with a target segment length of L, the data input into the multi-level bidirectional long short-term memory network is {x₁, x₂, x₃, . . . , x_{L}}, where xi (the i is taken to be 1, 2, 3, . . . , L) is an i-th sampling point in the logging curve fragment, and the sampling points are input into a network layer A of the multi-level bidirectional long short-term memory network in the order of the sequence. The first-level low-frequency component obtained after performing the first wavelet decomposition on the target segment length of the logging curve, as well as the second-level low-frequency component obtained after performing the second wavelet decomposition are respectively input into a network layer B and a network layer C of the multi-level bidirectional long short-term memory network. Where, the network layer A, the network layer B and the network layer C of the multi-level bidirectional long short-term memory network have almost the same network structure, and the difference lies in that the number of input layer nodes is different. This is because a size of the low-frequency component of the logging curve segment obtained after the wavelet decomposition is smaller than the size of the logging curve segment before the wavelet decomposition.

After slicing five logging curves, except the depth curve, of the logging curves in a selected block of the present application according to an alternative length, a training set and a verification set are divided by 9:1, and are input into the constructed multi-level bidirectional long short-term memory network for stratigraphic division, that is, 90% of the data after slicing is used for training the model, and 10% of the data is used for verifying the performance of the model.

The relevant training parameters of the multi-level bidirectional long short-term memory network are set, where a training iteration number is set to be 50, a training batch size is set to be 1024, an initial learning rate of the network is set to be 0.01 and the learning rate decays to 90% of its previous value after each training iteration, and a cross entropy loss function is selected as a loss function. After completion of training, the stratigraphic division results based on each of the logging curves are given on the test set.

S208, inputting the sample point data of the target segment length of each of the second logging curves and the multi-scale component corresponding to each of the second logging curves into a pre-constructed long short-term memory network to obtain a second stratigraphic division conclusion corresponding to each of the second logging curves output by the long short-term memory network.

In the present embodiment, the sample point data of the target segment length of each of the second logging curves and the multi-scale component corresponding to each of the second logging curves are input into the pre-constructed long short-term memory network, so as to obtain the second stratigraphic division conclusion based on the long short-term memory network and each of the second logging curves. The multi-level bidirectional long short-term memory network constructed in the present application is compared with conventional long short-term memory networks through experiments, so as to prove superiority of the constructed multi-level bidirectional long short-term memory network.

S209, obtaining a first stratigraphic division fusion conclusion obtained by fusing a plurality of the first stratigraphic division conclusions and a second stratigraphic division fusion conclusion obtained by fusing a plurality of the second stratigraphic division conclusions through a pre-stored adaptive fusion network according to a plurality of the first stratigraphic division conclusions and a plurality of the second stratigraphic division conclusions.

In the present embodiment, the first stratigraphic division fusion conclusion and the second stratigraphic division fusion conclusion that fuse a plurality of the first stratigraphic division conclusions and a plurality of the second stratigraphic division conclusions may be obtained through the pre-stored adaptive fusion network.

On the one hand, the first stratigraphic division fusion conclusion obtained by the multi-level bidirectional long short-term memory network constructed in the present application is compared with the second stratigraphic division fusion conclusion obtained by the conventional long short-term memory networks through experiments, which can prove the superiority of the multi-level bidirectional long short-term memory network constructed in the present application. On the other hand, the first stratigraphic division fusion conclusion and the second stratigraphic division fusion conclusion are respectively compared with a plurality of the first stratigraphic division conclusions and a plurality of the second stratigraphic division conclusions, which can prove the superiority of the first stratigraphic division fusion conclusion and the second stratigraphic division fusion conclusion.

The constructed adaptive fusion network consists of two multi-layer partially connected networks. In the present embodiment, taking a two-layer partially connected network as an example, the first layer is a hidden layer with k nodes, and the second layer is an output layer with 1 node.

In the present embodiment, a first fusion network formula and a second fusion network formula are pre-stored in the adaptive fusion network, and when the adaptive fusion network is the two-layer partially connected network, a first prediction probability is obtained through the first fusion network formula according to a plurality of the first stratigraphic division conclusions; and the first fusion network formula is:

$${\tilde{P}}_{j} = ( ReLU ( {G}_{j} {W}_{k} + {b}_{k} ) ) {W}_{1} + {b}_{1}$$

where, \tilde{P}ⱼ is the first prediction probability, ReLU( )is a linear correction function, Gⱼ is a fusion conclusion obtained according to a plurality of the first stratigraphic division conclusions, Wₖ is a partially connected layer with k nodes, bₖ is a bias of the partially connected layer, W₁ is an output layer, and b₁ is a bias of the output layer;
the first stratigraphic division fusion conclusion is obtained according to the first prediction probability;
a second prediction probability is obtained through a second fusion network formula according to a plurality of the second stratigraphic division conclusions; and the second fusion network formula is:

$$= ( ReLU ( {G}_{m} {W}_{k} + {b}_{k} ) ) {W}_{1} + {b}_{1}$$

where, [symbol] is the second prediction probability, and Gₘ is a fusion conclusion according to a plurality of the second stratigraphic division conclusions; and
the second stratigraphic division fusion conclusion is obtained according to the second prediction probability.

The decisions between various strata do not interfere with each other, and only relate to a predictive ability of a plurality of the logging curves for that stratum, and the prediction of each logging curve for other strata do not interfere with the prediction result for that stratum.

The present embodiment provides a specific formula that the first stratigraphic division fusion conclusion obtained by fusing a plurality of the first stratigraphic division conclusions, as well as the second stratigraphic division fusion conclusion obtained by fusing a plurality of the second layer division conclusions are obtained through the pre-stored adaptive fusion network according to a plurality of the first stratigraphic division conclusions and a plurality of the second stratigraphic division conclusions.

S210, obtaining respective stratigraphic division accuracy rates corresponding to a plurality of the first stratigraphic division conclusions, a plurality of the second stratigraphic division conclusions, the first stratigraphic division fusion conclusion and the second stratigraphic division fusion conclusion.

In the present embodiment, a plurality of the first stratigraphic division conclusions, a plurality of the second stratigraphic division conclusions, the first stratigraphic division fusion conclusions and the second stratigraphic division fusion conclusions are compared with their respective actual conclusions, so as to obtain their respective stratigraphic division accuracy rates. Then, a comparison is made based on the stratigraphic division accuracy rates so as to demonstrate the superiority of the constructed multi-level bidirectional long short-term memory network and the superiority of the stratigraphic division conclusion fused with a single logging curve.

S211, obtaining a training result of the multi-level bidirectional long short-term memory network after completion of the training according to a plurality of the stratigraphic division accuracy rates.

In the present embodiment, the training result indicates that the training is successful, and is used to indicate the stratigraphic division accuracy rate of the multi-level bidirectional long short-term memory network after completion of the training is higher than that of the conventional long short-term memory networks.

As shown in Table 3, when the multi-level bidirectional long short-term memory network constructed in the present application is applied to the logging curves, the stratigraphic division accuracy rate of each logging curve is improved compared with the conventional long short-term memory networks, with the most significant improvement for the GR curve, about 3.5%.

The stratigraphic division accuracy rates obtained after performing feature extraction on each logging curve and then conducting adaptive fusion are significantly higher than the results of a stratigraphic division prediction performed on each logging curve individually.

Based on the multi-level bidirectional long short-term memory network, the stratigraphic division accuracy rates without the depth curve and with the depth curve can reach 84.952% and 89.916%, respectively, which are 1.9% and 1.3% higher than those of the conventional long short-term memory networks. When each logging curve is processed with the conventional long short-term memory networks for feature extraction and then sent into the adaptive fusion network constructed in the present application, the stratigraphic division accuracy rate of the stratigraphic division conclusion output by this adaptive fusion network is also higher than the stratigraphic division accuracy rate of the stratigraphic division conclusion based on a single logging curve. Therefore, the adaptive fusion network constructed by the present application has a better performance in multi-curve fusion.

TABLE 3

| | | | | | | Fusion (Without | Fusion (With |
|---|---|---|---|---|---|---|---|
| | GR | SP | AC | RT1 | RT2 | depth) | depth) |
| LSTM | 56.784 | 63.205 | 43.791 | 51.552 | 51.839 | 83.012 | 88.641 |
| Bi- | 60.252 | 65.493 | 44.212 | 53.412 | 52.305 | 84.952 | 89.916 |
| MLSTM | | | | | | | |

The present application provides a model training method and a stratigraphic division conclusion extraction method. Based on the methods, the following technical effects have been achieved: by performing the multi-scale wavelet decomposition on the logging curves, temporal features of the logging data are extracted at multiple scales, so as to obtain richer features and facilitate obtaining a more accurate stratigraphic division. By combining the traditional wavelet transformation with the multi-level bidirectional long short-term memory network in deep learning, the features obtained after the wavelet transformation does not need to be analyzed artificially, and the temporal components of the logging curves can be automatically learned from multiple scales, thereby automatically obtaining the stratigraphic division conclusions based on different curves. An adaptive weight fusion is performed on the stratigraphic division conclusion based on a single logging curve, and then the prediction of the stratigraphic division is performed, which is beneficial to improving the accuracy of logging interpretation task conclusions.

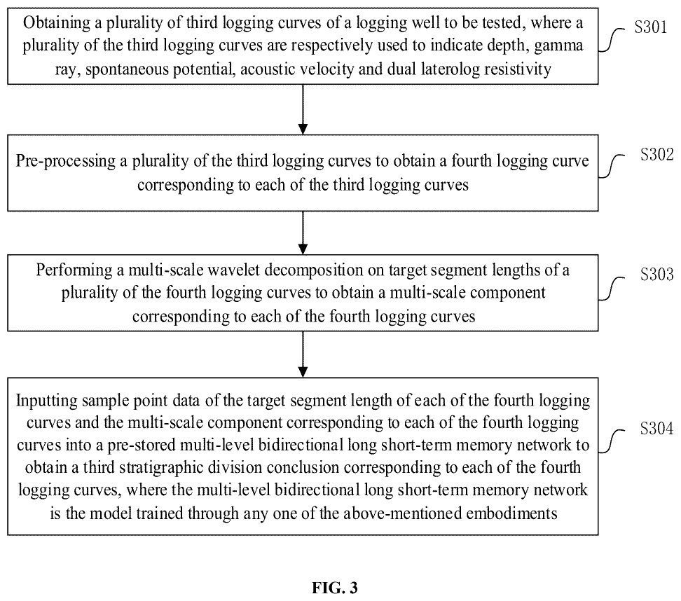

FIG. 3 is a first schematic flowchart of a stratigraphic division conclusion extraction method provided in an embodiment of the present application. As shown in FIG. 3, the stratigraphic division conclusion extraction method provided in this embodiment includes the following steps.

S301, obtaining a plurality of third logging curves of a logging well to be tested, where a plurality of the third logging curves are respectively used to indicate depth, gamma ray, spontaneous potential, acoustic velocity and dual laterolog resistivity.

In the present embodiment, a plurality of the third logging curves refer to a depth curve, a gamma ray curve, a spontaneous potential curve, an acoustic velocity curve, and a dual laterolog resistivity curve. The depth curve, the gamma ray curve, the spontaneous potential curve, the acoustic velocity curve and the dual laterolog resistivity curve of the logging well to be tested are taken as the basis for extracting the stratigraphic division conclusions.

S302, pre-processing a plurality of the third logging curves to obtain a fourth logging curve corresponding to each of the third logging curves.

In the present embodiment, the fourth logging curve corresponding to each of the third logging curves refers to the depth curve, the gamma ray curve, the spontaneous potential curve, the acoustic velocity curve and the dual laterolog resistivity curve after pre-processing. The depth curve, the gamma ray curve, the spontaneous potential curve, the acoustic velocity curve and the dual laterolog resistivity curve of the logging well to be tested are pre-processed, and the pre-processing manner may be carried out in the manner described in S202 or by other manners.

In the present embodiment, the effect of the pre-processing is similar to that of the pre-processing in S102 in the first embodiment of the present application, and thus will not be repeated herein.

S303, performing a multi-scale wavelet decomposition on target segment lengths of a plurality of the fourth logging curves to obtain a multi-scale component corresponding to each of the fourth logging curves.

In the present embodiment, the effect of performing the multi-scale wavelet decomposition in S303 is similar to that of performing the multi-scale wavelet decomposition in S103 in the first embodiment of the present application, and thus will not be repeated herein.

S304, inputting sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves.

In the present embodiment, the multi-level bidirectional long short-term memory network is the model trained through the first or second embodiment mentioned above. The sample point data of the target segment lengths of the depth curve, the gamma ray curve, the spontaneous potential curve, the acoustic velocity curve and the dual laterolog resistivity curve after pre-processing, as well as the multi-scale components respectively corresponding thereto, are input the trained multi-level bidirectional long short-term memory network, so as to automatically extract the stratigraphic division conclusions of the depth curve, the gamma ray curve, the spontaneous potential curve, the acoustic velocity curve and the dual laterolog resistivity curve.

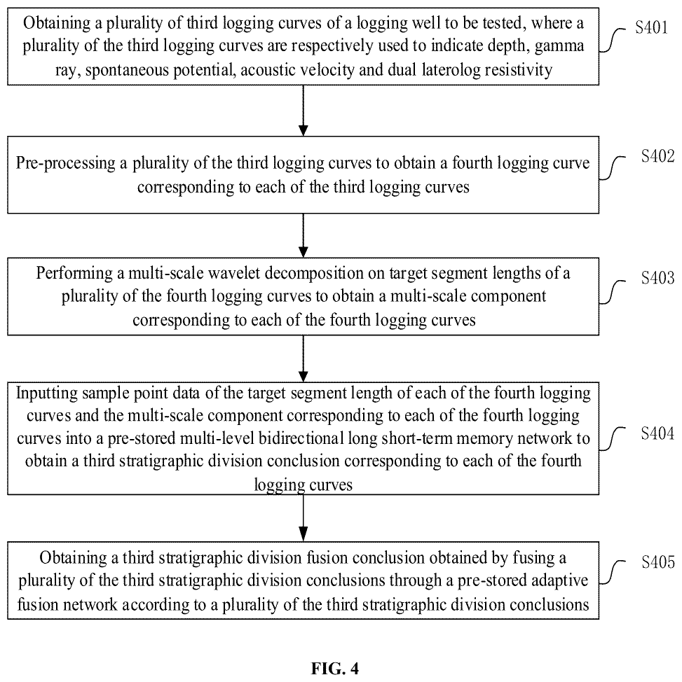

FIG. 4 is a second schematic flowchart of the stratigraphic division conclusion extraction method according to an embodiment of the present application. As shown in FIG. 4, the stratigraphic division conclusion extraction method provided in this embodiment is a further refinement based on the stratigraphic division conclusion extraction method provided in the previous embodiment of the present application. The stratigraphic division conclusion extraction method provided in this embodiment includes the following steps.

S401, obtaining a plurality of third logging curves of a logging well to be tested, where a plurality of the third logging curves are respectively used to indicate depth, gamma ray, spontaneous potential, acoustic velocity and dual laterolog resistivity.

In the present embodiment, the effect of S401 is similar to that of S301 in the previous embodiment of the present application, and thus will not be repeated herein.

S402, pre-processing a plurality of the third logging curves to obtain a fourth logging curve corresponding to each of the third logging curves.

In the present embodiment, the effect of S402 is similar to that of S302 in the previous embodiment of the present application, and thus will not be repeated herein.

S403, performing a multi-scale wavelet decomposition on target segment lengths of a plurality of the fourth logging curves to obtain a multi-scale component corresponding to each of the fourth logging curves.

In the present embodiment, the effect of performing the multi-scale wavelet decomposition in S403 is similar to that in S103 of the first embodiment of the present application, and thus will not be repeated herein.

S404, inputting sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves.

In the present embodiment, the multi-level bidirectional long short-term memory network is the model obtained through the first or second embodiment mentioned above.

The method of extracting the stratigraphic division conclusion in S404 is similar to that in S304 in the previous embodiment of the present application, and thus will not be repeated herein.

S405, obtaining a third stratigraphic division fusion conclusion obtained by fusing a plurality of the third stratigraphic division conclusions through a pre-stored adaptive fusion network according to a plurality of the third stratigraphic division conclusions.

In the present embodiment, a third fusion network formula is pre-stored in the adaptive fusion network, and when the adaptive fusion network is the two-layer partially connected network, a third prediction probability is obtained through the third fusion network formula according to a plurality of the third stratigraphic division conclusions; and the third fusion network formula is:

$$= ( ReLU ( {G}_{n} {W}_{k} + {b}_{k} ) ) {W}_{1} + {b}_{1}$$

where, [symbol] is the third prediction probability, ReLU( )is a linear correction function, Gⱼ is a fusion conclusion obtained according to a plurality of the third stratigraphic division conclusions, Wₖ is a partially connected layer with k nodes, bₖ is a bias of the partially connected layer, W₁ is an output layer, and b₁ is a bias of the output layer; and
the third stratigraphic division fusion conclusion is obtained according to the third prediction probability.

In the embodiments of the present application, functional modules of an electronic device or a main control device can be divided according to the above-mentioned method examples.

For example, the functional modules may be divided corresponding to each function, or two or more functions may be integrated into one processing unit. The above-mentioned integrated unit may be implemented in a form of hardware, and may also be implemented in a form of software functional modules. It should be noted that the division of modules in the embodiments of the present application is illustrative, which is merely a logical function division and may be other division methods in actual implementation.

FIG. 5 is a schematic structural diagram of a model training apparatus according to an embodiment of the present application. As shown in FIG. 5, in this embodiment, the model training apparatus 500 may be located in an electronic device. The model training apparatus includes:
an obtaining module 501 configured to obtain a plurality of first logging curves of a target logging well, where a plurality of the first logging curves are respectively configured to indicate depth, natural gamma, natural potential, acoustic time difference and bilateral resistivity;
a pre-processing module 502 configured to pre-process a plurality of the first logging curves to obtain a second logging curve corresponding to each of the first logging curves;
a wavelet decomposing module 503 configured to perform a multi-scale wavelet decomposition on target segment lengths of a plurality of second logging curves to obtain a multi-scale component corresponding to each of the second logging curves; and
a training module 504 configured to input sample point data of the target segment length of each of the second logging curves and the multi-scale component corresponding to each of the second logging curves into a pre-constructed multi-level bidirectional long short-term memory network so as to train the multi-level bidirectional long short-term memory network; where the multi-level bidirectional long short-term memory network is constructed by a plurality of bidirectional long short-term memory networks with different network parameters; and the multi-level bidirectional long short-term memory network after training is configured to output a first stratigraphic division conclusion corresponding to each of the second logging curves.

The model training apparatus provided in the present embodiment may execute the technical solution of the embodiment of the model training method shown in FIG. 1, and the implementation principles and technical effects thereof are similar to those of the embodiment of the model training method shown in FIG. 1, and will not be repeated herein.

At the same time, the model training apparatus provided in the present application further refines the model training apparatus 500 based on the model training apparatus provided in the previous embodiment.

In the present embodiment, the pre-processing module 502 is specifically configured to:
perform outlier processing on a first target logging curve which is any one of a plurality of the first logging curves; and
normalize the sampling point data of the first logging curve after the outlier processing through a normalization processing formula, so as to obtain the sampling point data of the second logging curve corresponding to the first target logging curve.

In the present embodiment, the wavelet decomposing module 503 is specifically configured to:
obtain a target segment length, target decomposition wavelet basis and a target decomposition level of a second target logging curve, which is any one of a plurality of the second logging curves, according to a pre-stored stratigraphic division accuracy rate;
perform at least one wavelet decomposition on the target segment length of the second target logging curve according to the target decomposition level and the target decomposition wavelet basis of the second target logging curve; and
obtain the multi-scale component corresponding to the second target logging curve according to low-frequency components obtained from each wavelet decomposition; where the multi-scale component corresponding to the second target logging curve refers to a set of at least one low-frequency component.

In an embodiment, when performing at least one wavelet decomposition on the target segment length of the second target logging curve according to the target decomposition level and the target decomposition wavelet basis of the second target logging curve, the wavelet decomposing module 503 performs at least one wavelet decomposition on the target segment length of the second target logging curve according to the target decomposition wavelet basis of the second target logging curve, until that the number of the wavelet decompositions reaches the target decomposition level of the second target logging curve; and
a target-order wavelet decomposition is any one of the at least one wavelet decomposition, and after performing the target-order wavelet decomposition on the target segment length of the second target logging curve according to the target decomposition wavelet basis of the second target logging curve, the method further includes:
updating the target segment length to the low-frequency component obtained from the target-order wavelet decomposition.

In the present embodiment, the multi-level bidirectional long short-term memory network includes n+1 network layers, and the target segment length of the second target logging curve is subjected to the wavelet decomposition for n times, the training module 504 is specifically configured to:
input the sample point data of the target segment length of each of the second logging curves into a first network layer of the multi-level bidirectional long short-term memory network; and
input the low-frequency component obtained from the i-th wavelet decomposition into an (i+1)th network layer of the multi-level bidirectional long short-term memory network, so as to train the multi-level bidirectional long short-term memory network; where the i is a positive integer less than or equal to the n.

In the present embodiment, in addition to the above modules, the model training apparatus 500 further includes a fusion module 505, where the fusion module 505 is specifically configured to:
input the sample point data of the target segment length of each of the second logging curves and the multi-scale component corresponding to each of the second logging curves into a pre-constructed long short-term memory network to obtain a second stratigraphic division conclusion corresponding to each of the second logging curves output by the long short-term memory network;
obtain a first stratigraphic division fusion conclusion obtained by fusing a plurality of the first stratigraphic division conclusions and a second stratigraphic division fusion conclusion obtained by fusing a plurality of the second stratigraphic division conclusions through a pre-stored adaptive fusion network according to a plurality of the first stratigraphic division conclusions and a plurality of the second stratigraphic division conclusions;
obtain respective stratigraphic division accuracy rates for a plurality of the first stratigraphic division conclusions, a plurality of the second stratigraphic division conclusions, the first stratigraphic division fusion conclusion and the second stratigraphic division fusion conclusion; and
obtain a training result of the multi-level bidirectional long short-term memory network after completion of the training according to a plurality of the stratigraphic division accuracy rates, where the training result indicates that the training is successful, and is used to indicate that the stratigraphic division accuracy rate of the multi-level bidirectional long short-term memory network after completion of the training is higher than the stratigraphic division accuracy rate of the long short-term memory network.

In an embodiment, when the fusion module 505 obtains the first stratigraphic division fusion conclusion obtained by fusing a plurality of the first stratigraphic division conclusions and the second stratigraphic division fusion conclusion obtained by fusing a plurality of the second stratigraphic division conclusions through the pre-stored adaptive fusion network according to a plurality of the first stratigraphic division conclusions and a plurality of the second stratigraphic division conclusions, a first fusion network formula and a second fusion network formula are pre-stored in the adaptive fusion network;
when the adaptive fusion network is a two-layer partially connected network, a first prediction probability is obtained according to a plurality of the first stratigraphic division conclusions through a first fusion network formula; and the first fusion network formula is:

$${\tilde{P}}_{j} = ( ReLU ( {G}_{j} {W}_{k} + {b}_{k} ) ) {W}_{1} + {b}_{1}$$

where, \tilde{P}ⱼ is the first prediction probability, ReLU( )is a linear correction function, Gⱼ is a fusion conclusion obtained according to a plurality of the first stratigraphic division conclusions, Wₖ is a partially connected layer with k nodes, bₖ is a bias of the partially connected layer, W₁ is an output layer, and b₁ is a bias of the output layer;
the first stratigraphic division fusion conclusion is obtained according to the first prediction probability;
a second prediction probability is obtained according to a plurality of the second stratigraphic division conclusions through a second fusion network formula; and the second fusion network formula is:

$$= ( ReLU ( {G}_{m} {W}_{k} + {b}_{k} ) ) {W}_{1} + {b}_{1}$$

where, [symbol] is the second prediction probability, and Gₘ is a fusion conclusion according to a plurality of the second stratigraphic division conclusions; and
the second stratigraphic division fusion conclusion is obtained according to the second prediction probability.

The model training apparatus provided in the present embodiment may execute the technical solutions of the embodiments of the model training method shown in FIGS. 1 and 2, and the implementation principles and technical effects thereof are similar to those of the embodiments of the model training method shown in FIGS. 1 and 2 and will not be repeated herein.

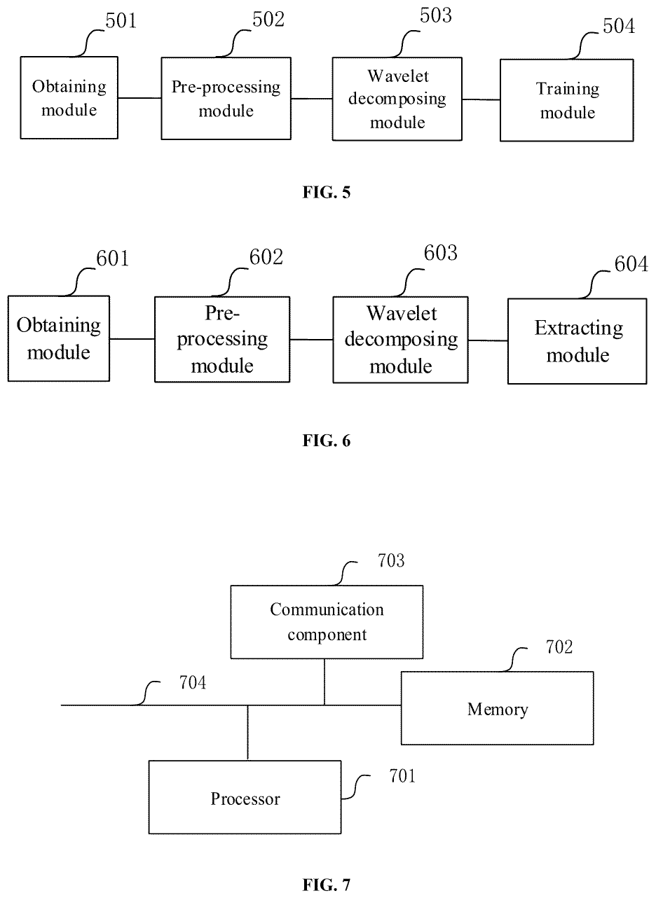

FIG. 6 is a schematic structural diagram of a stratigraphic division conclusion extraction apparatus provided in an embodiment of the present application. As shown in FIG. 6, in the present embodiment, the stratigraphic division conclusion extraction apparatus 600 may be located in an electronic device. The stratigraphic division conclusion extraction training apparatus 600 includes:
an obtaining module 601, configured to obtain a plurality of third logging curves of a logging well to be tested, where a plurality of the third logging curves are respectively used to indicate depth, gamma ray, spontaneous potential, acoustic velocity and dual laterolog resistivity;
a pre-processing module 602, configured to preprocess a plurality of the third logging curves to obtain a fourth logging curve corresponding to each of the third logging curves;
a wavelet decomposing module 603, configured to perform a multi-scale wavelet decomposition on target segment lengths of a plurality of the fourth logging curves to obtain a multi-scale component corresponding to each of the fourth logging curves; and
an extracting module 604, configured to input sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves.

The stratigraphic division conclusion extraction apparatus provided in the present embodiment may execute the technical solution of the embodiment of the stratigraphic division conclusion extraction method shown in FIG. 3, and the implementation principles and technical effects thereof are similar to those of the embodiment of the stratigraphic division conclusion extraction method shown in FIG. 3, and will not be repeated herein.

At the same time, based on the stratigraphic division conclusion extraction apparatus provided in the previous embodiment, the stratigraphic division conclusion extraction apparatus provided in the present application further refines the stratigraphic division conclusion extraction apparatus 600.

In the present embodiment, in addition to the above modules, the stratigraphic division conclusion extraction apparatus 600 further includes a fusion module 605, where the fusion module 605 is specifically configured to:
obtain a third stratigraphic division fusion conclusion obtained by fusing a plurality of third stratigraphic division conclusions through the pre-stored adaptive fusion network according to a plurality of the third stratigraphic division conclusions.

In an embodiment, when the convergence fusion 605 obtains the third stratigraphic division fusion conclusion obtained by fusing a plurality of the third stratigraphic division conclusions through the pre-stored adaptive fusion network according to a plurality of the third stratigraphic division conclusions, a third fusion network formula is pre-stored in the adaptive fusion network;
when the adaptive fusion network is a two-layer partially connected network, a third prediction probability is obtained according to a plurality of the third stratigraphic division conclusions through the third fusion network formula; and the fusion network formula is:

$$= ( ReLU ( {G}_{n} {W}_{k} + {b}_{k} ) ) {W}_{1} + {b}_{1}$$

where, [symbol] is the third prediction probability, ReLU( )is a linear correction function, Gⱼ is a fusion conclusion obtained according to a plurality of the third stratigraphic division conclusions, Wₖ is a partially connected layer with k nodes, bₖ is a bias of the partially connected layer, W₁ is an output layer, and b₁ is a bias of the output layer; and
the third formation division fusion conclusion is obtained according to the third prediction probability.

The stratigraphic division conclusion extraction apparatus provided in the present embodiment may execute the technical solution of the embodiment of the stratigraphic division conclusion extraction method shown in FIGS. 3 and 4, and the implementation principles and technical effects thereof are similar to those of the embodiment of the stratigraphic division conclusion extraction method shown in FIGS. 3 and 4, and will not be repeated herein.

FIG. 7 is a schematic structural diagram of an electronic device provided in an embodiment of the present application, and the electronic device refers to various electronic devices that can perform the model training method or the stratigraphic division conclusion extraction method, such as microcomputers, microcontrollers, and other suitable computers. The components, their connections and relationships, and their functions shown in the present application are merely exemplary and are not intended to limit implementation of the present application described and/or required herein.

As shown in FIG. 7, the electronic device 70 includes at least one processor 701 and a memory 702. The electronic device further includes a communication component 703. The processor 701, the memory 702, and the communication component 703 are connected through a bus 704.

In a specific implementation, the at least one processor 701 executes computer-executable instructions stored in the memory 702, so that the at least one processor 701 executes the model training method or the stratigraphic division conclusion extraction method executed on the electronic device side as described above.

The specific implementation process of the processor 701 may refer to the embodiments of the above-mentioned model training methods or the embodiments of the stratigraphic division conclusion extraction methods, and the implementation principles and technical effects thereof are similar, and will not be repeated herein.

In the above-mentioned embodiments, it should be understood that the processor 701 may be a central processing unit (CPU), and may also be another general processor, a digital signal processor (DSP), an application specific integrated circuit (ASIC), etc. The general processor 701 may be a microprocessor, or any conventional processor. The steps of the methods disclosed in the present application may be directly implemented by a hardware processor or by a combination of hardware and software modules in the processor.

The memory 702 may include a high-speed RAM memory, and may also include a non-volatile memory NVM, such as at least one disk memory.

The bus 704 may be an industry standard architecture (ISA) bus, a peripheral component (PCI) bus, an extended industry standard architecture (EISA) bus, etc. The bus 704 may be classified into an address bus, a data bus, a control bus, etc. For ease of representation, the bus 704 in the accompanying drawings of the present application is not limited to only one bus or one type of bus.

The solution provided by the embodiments of the present application is introduced by the functions implemented by the electronic device and the main control device above. It can be understood that, in order to implement the foregoing functions, the electronic device or the main control device includes hardware structures and/or software modules that perform respective functions. In conjunction with the examples of units and algorithmic steps described in the embodiments of the present application, the embodiments of the present application may be implemented in the form of hardware or a combination of hardware and computer software. Whether a certain function is executed through hardware or computer software driving hardware depends on specific applications and design constraint conditions of the technical solution. Those skilled in the art may use different methods to implement the described functions for each specific application, but such implementations shall not be considered beyond the scope of the technical solution of the embodiments of the present application.

The present application further provides a computer-readable storage medium, where the computer-readable storage medium stores computer-executable instructions which, when being executed by a processor, implement the model training method or the stratigraphic division conclusion extraction method mentioned above.

The above-mentioned computer-readable storage medium can be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The readable storage medium may be any available medium that can be accessed by a general purpose or special purpose computer.

An exemplary readable storage medium is coupled to the processor, so that the processor can read the information from the readable storage medium and can write information to the readable storage medium. The readable storage media can also be a component of the processor. The processor and the readable storage medium may be located in an application specific integrated circuit (ASIC). The processor and the readable storage medium may also be separate components in the electronic device or the main control device.

The memory 702 is a non-transitory computer-readable storage medium provided by the present application. The non-transitory computer readable storage medium of the present application stores computer instructions which are used to enable the computer to execute the model training method or the stratigraphic division conclusion extraction method provided by the present application.

The memory 702, as the non-transitory computer-readable storage medium, may be configured to store non-transitory software programs, non-transitory computer-executable programs and modules, such as program instructions/modules corresponding to the model training method or the stratigraphic division conclusion extraction method in the embodiments of the present application (e.g., the obtaining module 501, the pre-processing module 502, the wavelet decomposing module 503 and the training module 504 shown in FIG. 5 or the obtaining module 601, the pre-processing module 602, the wavelet decomposing module 603 and the extracting module 604 shown in FIG. 6). The processor 701 executes various function applications and data processing by running the non-transitory software programs, instructions and modules stored in the memory 702, that is, implements the model training method or the stratigraphic division conclusion extraction method in the embodiments of the above-mentioned methods.

At the same time, the present embodiment further provides a computer program product, and when instructions in the computer program product are executed by the processor, the model training method or the stratigraphic division conclusion extraction method of the above-mentioned embodiments can be executed.

Those skilled in the art will easily come up with other embodiments of the present application after considering the specification and practicing the application disclosed herein. The present application is intended to cover any variations, uses, or adaptive changes of the present application, which follow the general principles of the present application and include common general knowledge or customary technical means in the art not disclosed in the present application. The specification and embodiments are only considered exemplary, and the true scope and spirit of the present application are indicated by the following claims.

It should be understood that the present application is not limited to the precise structure described above and shown in the drawings, and various modifications and changes may be made without departing from the scope of the present application. The scope of the present application is limited only by the appended claims.

What is claimed is:

1. A model training method, comprising:
obtaining a plurality of first logging curves of a target logging well, wherein a plurality of the first logging curves are respectively used to indicate depth, gamma ray, spontaneous potential, acoustic velocity and dual laterolog resistivity;
pre-processing a plurality of the first logging curves to obtain a second logging curve corresponding to each of the first logging curves;
performing a multi-scale wavelet decomposition on target segment lengths of a plurality of the second logging curves to obtain a multi-scale component corresponding to each of the second logging curves; and
inputting sample point data of the target segment length of each of the second logging curves and the multi-scale component corresponding to each of the second logging curves into a pre-constructed multi-level bidirectional long short-term memory network so as to train the multi-level bidirectional long short-term memory network; wherein the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

2. The model training method according to claim 1, wherein a second target logging curve is any one of a plurality of the second logging curves;
for the second target logging curve, the performing the multi-scale wavelet decomposition on the target segment lengths of a plurality of the second logging curves to obtain the multi-scale component corresponding to each of the second logging curves comprises:
obtaining a target segment length, target decomposition wavelet basis and a target decomposition level of the second target logging curve according to a pre-stored stratigraphic division accuracy rate;
performing at least one wavelet decomposition on the target segment length of the second target logging curve according to the target decomposition level and the target decomposition wavelet basis of the second target logging curve; and
obtaining the multi-scale component corresponding to the second target logging curve according to low-frequency components obtained from each wavelet decomposition; wherein the multi-scale component corresponding to the second target logging curve refers to a set of at least one of the low-frequency components.

3. The model training method according to claim 2, wherein the performing at least one wavelet decomposition on the target segment length of the second target logging curve according to the target decomposition level and the target decomposition wavelet basis of the second target logging curve comprises:
performing at least one wavelet decomposition on the target segment length of the second target logging curve according to the target decomposition wavelet basis of the second target logging curve, until that the number of the wavelet decompositions reaches the target decomposition level of the second target logging curve;
a target-order wavelet decomposition is any one of the at least one wavelet decomposition, and after performing the target-order wavelet decomposition on the target segment length of the second target logging curve according to the target decomposition wavelet basis of the second target logging curve, the method further comprises:
updating the target segment length to the low-frequency component obtained from the target-order wavelet decomposition.

4. The model training method according to claim 1, wherein after inputting the sample point data of the target segment length of each of the second logging curves and the multi-scale component corresponding to each of the second logging curves into the pre-constructed multi-level bidirectional long short-term memory network so as to train the multi-level bidirectional long short-term memory network, the method further comprises:
inputting the sample point data of the target segment length of each of the second logging curves and the multi-scale component corresponding to each of the second logging curves into a pre-constructed long short-term memory network to obtain a second stratigraphic division conclusion corresponding to each of the second logging curves output by the long short-term memory network;
obtaining a first stratigraphic division fusion conclusion obtained by fusing a plurality of the first stratigraphic division conclusions and a second stratigraphic division fusion conclusion obtained by fusing a plurality of the second stratigraphic division conclusions through a pre-stored adaptive fusion network according to a plurality of the first stratigraphic division conclusions and a plurality of the second stratigraphic division conclusions;
obtaining respective stratigraphic division accuracy rates for a plurality of the first stratigraphic division conclusions, a plurality of the second stratigraphic division conclusions, the first stratigraphic division fusion conclusion and the second stratigraphic division fusion conclusion; and
obtaining a training result of the multi-level bidirectional long short-term memory network after completion of the training according to a plurality of the stratigraphic division accuracy rates, wherein the training result indicates that the training is successful, and is used to indicate that the stratigraphic division accuracy rate of the multi-level bidirectional long short-term memory network after completion of the training is higher than the stratigraphic division accuracy rate of the long short-term memory network.

5. The model training method according to claim 4, wherein a first fusion network formula and a second fusion network formula are pre-stored in the adaptive fusion network;
when the adaptive fusion network is a two-layer partially connected network, the obtaining the first stratigraphic division fusion conclusion obtained by fusing a plurality of the first stratigraphic division conclusions and the second stratigraphic division fusion conclusion obtained by fusing a plurality of the second stratigraphic division conclusions through the pre-stored adaptive fusion network according to a plurality of the first stratigraphic division conclusions and a plurality of the second stratigraphic division conclusions comprises:
obtaining a first prediction probability according to a plurality of the first stratigraphic division conclusions through a first fusion network formula; and the first fusion network formula is:
$$\tilde{{P}_{j}} = ( ReLU ( {G}_{j} {W}_{k} + {b}_{k} ) ) {W}_{1} + {b}_{1}$$
wherein, \tilde{P}ⱼ is the first prediction probability, ReLU( )is a linear correction function, Gⱼ is a fusion conclusion obtained according to a plurality of the first stratigraphic division conclusions, Wₖ is a partially connected layer with k nodes, bₖ is a bias of the partially connected layer, W₁ is an output layer, and b₁ is a bias of the output layer;
obtaining the first stratigraphic division fusion conclusion according to the first prediction probability;
obtaining a second prediction probability according to a plurality of the second stratigraphic division conclusions through a second fusion network formula; and the second fusion network formula is:
$$= ( ReLU ( {G}_{m} {W}_{k} + {b}_{k} ) ) {W}_{1} + {b}_{1}$$
wherein, [symbol] is the second prediction probability, and Gₘ is a fusion conclusion according to a plurality of the second stratigraphic division conclusions; and
obtaining the second stratigraphic division fusion conclusion according to the second prediction probability.

6. The model training method according to claim 3, wherein the multi-level bidirectional long short-term memory network comprises n+1 network layers, and the target segment length of the second target logging curve is subjected to the wavelet decomposition for n times;
the inputting the sample point data of the target segment length of each of the second logging curves and the multi-scale component corresponding to each of the second logging curves into the pre-constructed multi-level bidirectional long short-term memory network so as to train the multi-level bidirectional long short-term memory network comprises:
inputting the sample point data of the target segment length of each of the second logging curves into a first network layer of the multi-level bidirectional long short-term memory network; and
inputting the low-frequency component obtained from the i-th wavelet decomposition into an (i+1)th network layer of the multi-level bidirectional long short-term memory network, so as to train the multi-level bidirectional long short-term memory network; wherein the i is a positive integer less than or equal to the n.

7. The model training method according to claim 1, wherein a first target logging curve is any one of a plurality of the first logging curves;
for the first target logging curve, the pre-processing a plurality of the first logging curves to obtain the second logging curve corresponding to each of the first logging curves comprises:
performing outlier processing on the first target logging curve; and
normalizing the sample point data of the first logging curve after the outlier processing through a normalization processing formula, so as to obtain the sample point data of the second logging curve corresponding to the first target logging curve.

8. A stratigraphic division conclusion extraction method, comprising:
obtaining a plurality of third logging curves of a logging well to be tested, wherein a plurality of the third logging curves are respectively used to indicate depth, gamma ray, spontaneous potential, acoustic velocity and dual laterolog resistivity;
pre-processing a plurality of the third logging curves to obtain a fourth logging curve corresponding to each of the third logging curves;
performing a multi-scale wavelet decomposition on target segment lengths of a plurality of the fourth logging curves to obtain a multi-scale component corresponding to each of the fourth logging curves; and
inputting sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves; wherein the multi-level bidirectional long short-term memory network is a model obtained by using the model training method according to claim 1.

9. The stratigraphic division conclusion extraction method according to claim 8, wherein a second target logging curve is any one of a plurality of the second logging curves;
for the second target logging curve, the performing the multi-scale wavelet decomposition on the target segment lengths of a plurality of the second logging curves to obtain the multi-scale component corresponding to each of the second logging curves comprises:
obtaining a target segment length, target decomposition wavelet basis and a target decomposition level of the second target logging curve according to a pre-stored stratigraphic division accuracy rate;
performing at least one wavelet decomposition on the target segment length of the second target logging curve according to the target decomposition level and the target decomposition wavelet basis of the second target logging curve; and
obtaining the multi-scale component corresponding to the second target logging curve according to low-frequency components obtained from each wavelet decomposition; wherein the multi-scale component corresponding to the second target logging curve refers to a set of at least one of the low-frequency components.

10. The stratigraphic division conclusion extraction method according to claim 9, wherein the performing at least one wavelet decomposition on the target segment length of the second target logging curve according to the target decomposition level and the target decomposition wavelet basis of the second target logging curve comprises:
performing at least one wavelet decomposition on the target segment length of the second target logging curve according to the target decomposition wavelet basis of the second target logging curve, until that the number of the wavelet decompositions reaches the target decomposition level of the second target logging curve;
a target-order wavelet decomposition is any one of the at least one wavelet decomposition, and after performing the target-order wavelet decomposition on the target segment length of the second target logging curve according to the target decomposition wavelet basis of the second target logging curve, the method further comprises:
updating the target segment length to the low-frequency component obtained from the target-order wavelet decomposition.

11. The stratigraphic division conclusion extraction method according to claim 8, wherein after inputting the sample point data of the target segment length of each of the second logging curves and the multi-scale component corresponding to each of the second logging curves into the pre-constructed multi-level bidirectional long short-term memory network so as to train the multi-level bidirectional long short-term memory network, the method further comprises:
inputting the sample point data of the target segment length of each of the second logging curves and the multi-scale component corresponding to each of the second logging curves into a pre-constructed long short-term memory network to obtain a second stratigraphic division conclusion corresponding to each of the second logging curves output by the long short-term memory network;
obtaining a first stratigraphic division fusion conclusion obtained by fusing a plurality of the first stratigraphic division conclusions and a second stratigraphic division fusion conclusion obtained by fusing a plurality of the second stratigraphic division conclusions through a pre-stored adaptive fusion network according to a plurality of the first stratigraphic division conclusions and a plurality of the second stratigraphic division conclusions;
obtaining respective stratigraphic division accuracy rates for a plurality of the first stratigraphic division conclusions, a plurality of the second stratigraphic division conclusions, the first stratigraphic division fusion conclusion and the second stratigraphic division fusion conclusion; and
obtaining a training result of the multi-level bidirectional long short-term memory network after completion of the training according to a plurality of the stratigraphic division accuracy rates, wherein the training result indicates that the training is successful, and is used to indicate that the stratigraphic division accuracy rate of the multi-level bidirectional long short-term memory network after completion of the training is higher than the stratigraphic division accuracy rate of the long short-term memory network.

12. The stratigraphic division conclusion extraction method according to claim 11, wherein a first fusion network formula and a second fusion network formula are pre-stored in the adaptive fusion network;
when the adaptive fusion network is a two-layer partially connected network, the obtaining the first stratigraphic division fusion conclusion obtained by fusing a plurality of the first stratigraphic division conclusions and the second stratigraphic division fusion conclusion obtained by fusing a plurality of the second stratigraphic division conclusions through the pre-stored adaptive fusion network according to a plurality of the first stratigraphic division conclusions and a plurality of the second stratigraphic division conclusions comprises:
obtaining a first prediction probability according to a plurality of the first stratigraphic division conclusions through a first fusion network formula; and the first fusion network formula is:
$$\tilde{{P}_{j}} = ( ReLU ( {G}_{j} {W}_{k} + {b}_{k} ) ) {W}_{1} + {b}_{1}$$
wherein, \tilde{P}ⱼ is the first prediction probability, ReLU( )is a linear correction function, Gⱼ is a fusion conclusion obtained according to a plurality of the first stratigraphic division conclusions, Wₖ is a partially connected layer with k nodes, bₖ is a bias of the partially connected layer, W₁ is an output layer, and b₁ is a bias of the output layer;
obtaining the first stratigraphic division fusion conclusion according to the first prediction probability;
obtaining a second prediction probability according to a plurality of the second stratigraphic division conclusions through a second fusion network formula; and the second fusion network formula is:
$$= ( ReLU ( {G}_{m} {W}_{k} + {b}_{k} ) ) {W}_{1} + {b}_{1}$$
wherein, [symbol] is the second prediction probability, and Gₘ is a fusion conclusion according to a plurality of the second stratigraphic division conclusions; and
obtaining the second stratigraphic division fusion conclusion according to the second prediction probability.

13. The stratigraphic division conclusion extraction method according to claim 10, wherein the multi-level bidirectional long short-term memory network comprises n+1 network layers, and the target segment length of the second target logging curve is subjected to the wavelet decomposition for n times;
the inputting the sample point data of the target segment length of each of the second logging curves and the multi-scale component corresponding to each of the second logging curves into the pre-constructed multi-level bidirectional long short-term memory network so as to train the multi-level bidirectional long short-term memory network comprises:
inputting the sample point data of the target segment length of each of the second logging curves into a first network layer of the multi-level bidirectional long short-term memory network; and
inputting the low-frequency component obtained from the i-th wavelet decomposition into an (i+1)th network layer of the multi-level bidirectional long short-term memory network, so as to train the multi-level bidirectional long short-term memory network; wherein the i is a positive integer less than or equal to the n.

14. The stratigraphic division conclusion extraction method according to claim 8, wherein a first target logging curve is any one of a plurality of the first logging curves;
for the first target logging curve, the pre-processing a plurality of the first logging curves to obtain the second logging curve corresponding to each of the first logging curves comprises:
performing outlier processing on the first target logging curve; and
normalizing the sample point data of the first logging curve after the outlier processing through a normalization processing formula, so as to obtain the sample point data of the second logging curve corresponding to the first target logging curve.

15. The stratigraphic division conclusion extraction method according to claim 8, wherein after inputting the sample point data of the target segment length of each of the fourth logging curves and the multi-scale component corresponding to each of the fourth logging curves into the pre-stored multi-level bidirectional long short-term memory network to obtain the third stratigraphic division conclusion corresponding to each of the fourth logging curves, the method further comprises:
obtaining a third stratigraphic division fusion conclusion obtained by fusing a plurality of the third stratigraphic division conclusions through a pre-stored adaptive fusion network according to a plurality of the third stratigraphic division conclusions.

16. The stratigraphic division conclusion extraction method according to claim 15, wherein a third fusion network formula is pre-stored in the adaptive fusion network;
when the adaptive fusion network is a two-layer partially connected network, the obtaining the third stratigraphic division fusion conclusion obtained by fusing a plurality of the third stratigraphic division conclusions through the pre-stored adaptive fusion network according to a plurality of the third stratigraphic division conclusions comprises:
obtaining a third prediction probability according to a plurality of the third stratigraphic division conclusions through the third fusion network formula; and the third fusion network formula is:
$$= ( ReLU ( {G}_{n} {W}_{k} + {b}_{k} ) ) {W}_{1} + {b}_{1}$$
wherein, [symbol] is the third prediction probability, ReLU( )is a linear correction function, Gⱼ is a fusion conclusion obtained according to a plurality of the third stratigraphic division conclusions, Wₖ is a partially connected layer with k nodes, bₖ is a bias of the partially connected layer, W₁ is an output layer, and b₁ is a bias of the output layer; and
obtaining the third stratigraphic division fusion conclusion according to the third prediction probability.

17. A model training apparatus, comprising: a processor and a memory in communication connection with the processor; wherein
the memory stores computer-executable instructions; and
the processor executes the computer-executable instructions stored in the memory, so as to implement the following steps:
obtaining a plurality of first logging curves of a target logging well, wherein a plurality of the first logging curves are respectively used to indicate depth, gamma ray, spontaneous potential, acoustic velocity and dual laterolog resistivity;
pre-processing a plurality of the first logging curves to obtain a second logging curve corresponding to each of the first logging curves;
performing a multi-scale wavelet decomposition on target segment lengths of a plurality of the second logging curves to obtain a multi-scale component corresponding to each of the second logging curves; and
inputting sample point data of the target segment length of each of the second logging curves and the multi-scale component corresponding to each of the second logging curves into a pre-constructed multi-level bidirectional long short-term memory network so as to train the multi-level bidirectional long short-term memory network; wherein the multi-level bidirectional long short-term memory network is constructed by a plurality of bidirectional long short-term memory networks with different network parameters; and the multi-level bidirectional long short-term memory network after completion of training is configured to output a first stratigraphic division conclusion corresponding to each of the second logging curves.

18. A stratigraphic division conclusion extraction apparatus, comprising: a processor and a memory in communication connection with the processor; wherein
the memory stores computer-executable instructions; and
the processor executes the computer-executable instructions stored in the memory, so as to implement the following steps:
obtaining a plurality of third logging curves of a logging well to be tested, wherein a plurality of the third logging curves are respectively used to indicate depth, gamma ray, spontaneous potential, acoustic velocity and dual laterolog resistivity;
pre-processing a plurality of the third logging curves to obtain a fourth logging curve corresponding to each of the third logging curves;
performing a multi-scale wavelet decomposition on target segment lengths of a plurality of the fourth logging curves to obtain a multi-scale component corresponding to each of the fourth logging curves; and
inputting sample point data of the target segment length of each of the fourth logging curves and the multi-scale component corresponding to each of the fourth logging curves into a pre-stored multi-level bidirectional long short-term memory network to obtain a third stratigraphic division conclusion corresponding to each of the fourth logging curves; wherein the multi-level bidirectional long short-term memory network is a model obtained by using the model training method according to claim 1.

19. A non-transitory computer-readable storage medium, wherein the non-transitory computer-readable storage medium stores computer-executable instructions that, when executed by a processor, enable the processor to implement the model training method according to claim 1.

20. A non-transitory computer-readable storage medium, wherein the non-transitory computer-readable storage medium stores computer-executable instructions that, when executed by a processor, enable the processor to implement the stratigraphic division conclusion extraction method according to claim 8.
